(19) United States
(12) Patent Application Publication
(10) Pub. No.: US 2004/0163633 A1
(43) Pub. Date: Aug. 26, 2004

(54) ELECTRICAL INTERFACE ASSEMBLY FOR REDUCING OHMIC LOSSES IN AN IGNITION SYSTEM

(76) Inventors: Albert Anthony Skinner, Anderson, IN (US); Larrie A. Davis, Mccordsville, IN (US); James Patrick Henry, Noblesville, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/373,149

(22) Filed: Feb. 24, 2003

(51) Int. Cl. F02P 1/00

(52) U.S. Cl. 123/634; 123/647

(57) ABSTRACT

An electrical interface assembly is provided for an ignition system including at least one ignition coil per cylinder in a multi-cylinder engine. Each ignition coil includes a plurality of coil terminals for passing respective electrical signals. One of the electrical signals may be used for discharging a respective spark in a respective cylinder. The interface assembly comprises a respective miniaturized printed circuit board (PCB) on each ignition coil. Each miniaturized PCB is electrically coupled to the coil terminals therein. The interface assembly further comprises a separate electrically conductive structure for electrically interconnecting each miniaturized PCB. The electrically conductive structure may be configured to reduce ohmic losses due to inter-cylinder separation in the electrical signal used for discharging the respective spark.

### BACKGROUND OF THE INVENTION

The present invention is generally related to electrical interface assemblies, and, more particularly, to an interface assembly for an ignition system.

Ignition coil cassettes, such as may be used in the ignition system of a multi-cylinder Otto-type internal combustion engine equipped with at least one ignition coil assembly per cylinder, commonly include a printed circuit board (PCB) to electrically interconnect the coils and provide interface through a single connector to a wiring harness for the engine. Generally, the cost of the printed circuit board is directly proportional to the area of the printed circuit board. Therefore, as each ignition coil, e.g., pencil coil, is placed in a respective cylinder well, the spacing between the coils in typical applications may range from approximately 90 to 120 mm. This length incrementally drives the cost of the PCB to unacceptably high levels in the rather competitive business environment presently faced by suppliers of automotive equipment, such as the assignee of the present invention.

The relatively long electrically conductive pathways provided on the PCB, may also add undesirable impedance (e.g., resistance) to any coil placed relatively far away from the harness connector and this may affect operational performance of the ignition system under certain conditions, such as a low battery voltage condition. For example, in one known design, an additional 0.076 ohms of series resistance due to the relatively lengthy PCB, is believed to result in a loss of approximately 2 kV in the secondary coil output voltage during a low battery voltage condition.

In view of the foregoing considerations, it would be desirable to provide an improved electrical interface assembly for an ignition system that avoids use of an expensive PCB with relatively long electrically conductive pathways. It would be further desirable to provide an interface assembly that at a relatively lower cost provides reliable electrical coupling to the ignition system.

### BRIEF SUMMARY OF THE INVENTION

Generally, the present invention fulfills the foregoing needs by providing in one aspect thereof, an electrical interface assembly for an ignition system including at least one ignition coil per cylinder in a multi-cylinder engine. Each ignition coil includes a plurality of coil terminals for passing respective electrical signals. One of the electrical signals is used for discharging a respective spark in a respective cylinder. The interface assembly comprises a respective miniaturized printed circuit board (PCB) on each ignition coil. Each miniaturized PCB is electrically coupled to the coil terminals therein. The interface assembly further comprises a separate electrically conductive structure for electrically interconnecting each miniaturized PCB. The electrically conductive structure may be configured to reduce ohmic losses due to inter-cylinder separation in the electrical signal used for discharging the respective spark.

In another aspect thereof, the present invention further fulfills the foregoing needs by providing an ignition system for a multi-cylinder engine. The system comprises at least one ignition coil per cylinder. Each ignition coil includes a plurality of coil terminals for passing respective electrical signals. One of the electrical signals is used for discharging a respective spark in a respective cylinder. The system further comprises an electrical interface assembly. The interface assembly is made up of a respective miniaturized printed circuit board (PCB) on each ignition coil. Each miniaturized PCB is electrically coupled to the coil terminals therein. The interface assembly is further made up of a separate electrically conductive structure for electrically interconnecting each miniaturized PCB. The electrically conductive structure may be configured to reduce ohmic losses due to inter-cylinder separation in the electrical signal used for discharging the respective spark.

### BRIEF DESCRIPTION OF THE DRAWINGS

The features and advantages of the present invention will become apparent from the following detailed description of the invention when read with the accompanying drawings in which:

FIG. 1 is a top view of an exemplary embodiment of an electrical interface assembly for an ignition system embodying aspects of the present invention.

FIG. 2 is a cross-sectional view along line A-A of the interface assembly of FIG. 1.

FIG. 3 illustrates an exemplary embodiment of an electrically conductive structure made up of a stamped lead frame for interconnecting respective miniaturized PCB boards.

FIG. 4 is a side view of the lead frame of FIG. 3 as may be assembled for electrically interconnecting two miniaturized PCB boards.

FIG. 5 is a top view of the assemblage of FIG. 4.

### DETAILED DESCRIPTION OF THE INVENTION

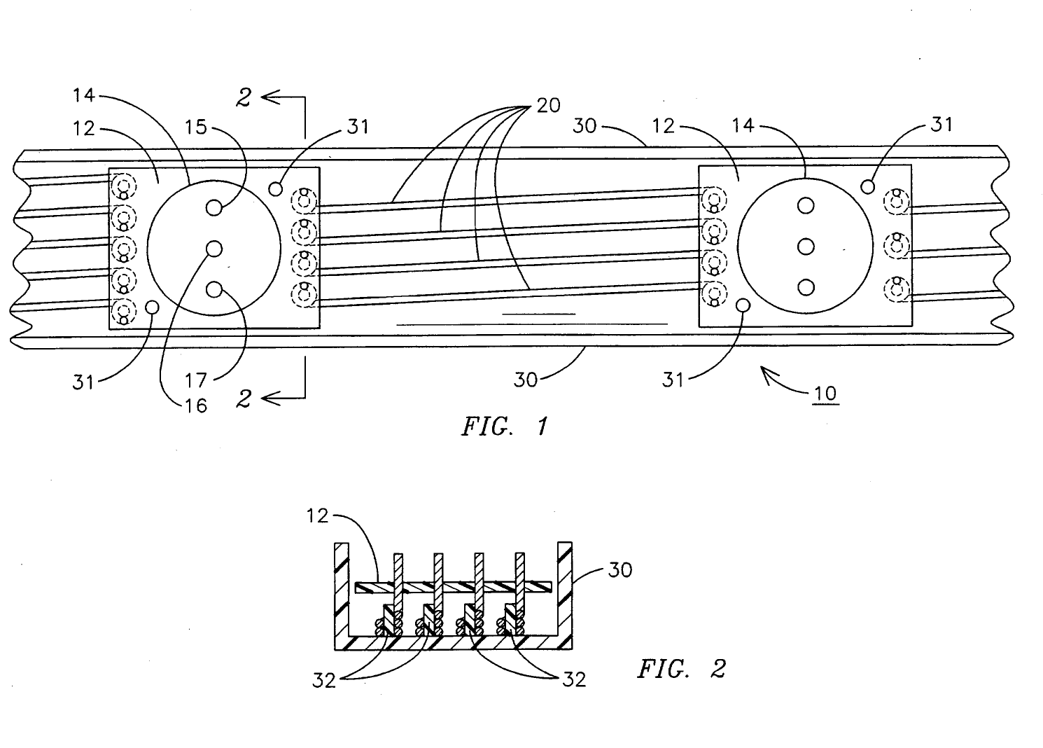

FIG. 1 is a top view of an exemplary embodiment of an electrical interface assembly 10 embodying aspects of the present invention. The electrical interface assembly may be used in a so called ignition coil cassette, part of an ignition system of a multi-cylinder spark-ignited internal combustion engine equipped with at least one ignition coil assembly per cylinder. Interface assembly 10 comprises a miniaturized printed circuit board (PCB) 12 for each ignition coil 14. In one exemplary embodiment, each ignition coil may include a plurality of coil terminals, e.g., three coil terminals 15, 16, and 17, for passing a respective electrical signal, such as a pair of signals from each side of a primary winding of the ignition coil, and an electrical ground. Electrically conductive structure 20 is separately provided to interconnect each miniaturized PCB 12. The inventors of the present invention have innovatively recognized that use of a miniaturized PCB 12 for each coil and separate electrically conductive structure 20, in lieu of a relatively large PCB with long electrically conductive pathways thereon, allows for substantially reducing costs (in one exemplary embodiment approximately a five fold reduction or more is believed to be achievable) and for improving the operational performance of the electrical interface due to avoidance or reduction of ohmic losses in an electrical signal used for discharging a spark in a respective cylinder. In one exemplary embodiment, the area of each miniaturized PCB may range from approximately 15 to 20 mm². It is contemplated that the electrically conductive structure 20 may be implemented in a variety of ways. For example, the electrically conductive structure may comprise the following exemplary configurations: a set of round wires, such as round copper wires; a set of square terminal wires; a set of stamped lead frames; or any other electrically conductive and joinable (e.g., solderable) material with connecting points on the miniaturized PCB.

FIG. 2 is a cross-sectional view along line A-A of the interface assembly shown in FIG. 1. As seen in FIGS. 1 and 2, the electrically conductive structure may be arranged in a suitable plastic housing 30 or similar protective structure, e.g., a trough. The arrangement of the electrically conductive structure within housing 30 (or trough) may be performed prior to mounting each miniaturized PCB onto a respective coil. Each miniaturized PCB may include one or more anchor posts 31 (FIG. 1) for affixing the PCB on each coil. The electrically conductive structure may be electromechanically connected to each miniaturized PCB in a variety of ways, such as via a set of non-conductive wrap post 32 (FIG. 2) or snap interface configured to hold and locate each of the individual electrically conductive elements that collectively make up the electrically conductive structure. For example, assuming a round wire configuration, the wrap post would provide means for wrappingly supporting the round wire, and upwardly routing (e.g., by way of a 90 degree turn) the wire through the miniaturized PCB. Assuming a square wire configuration, each square wire may be bent (e.g., 90 degrees) to directly (e.g., without any post) provide electrical contact with any corresponding coil terminal. Thus, it will be appreciated that wrap posts 32 may or may not be used depending on the specific configuration of the electrically conductive structure 20. As will be now appreciated by those skilled in the art, the electrically conductive structure may be pre-formed and manually assembled, or may be cut to length, and located in the cassette using a microprocessor-controlled, automatic wire finishing system. The electrically conductive structure would then be joined (e.g., by soldering or any other metallurgical technique suitable for joining electrically conductive materials) with each miniaturized PCB, thus completing a low-cost interface assembly.

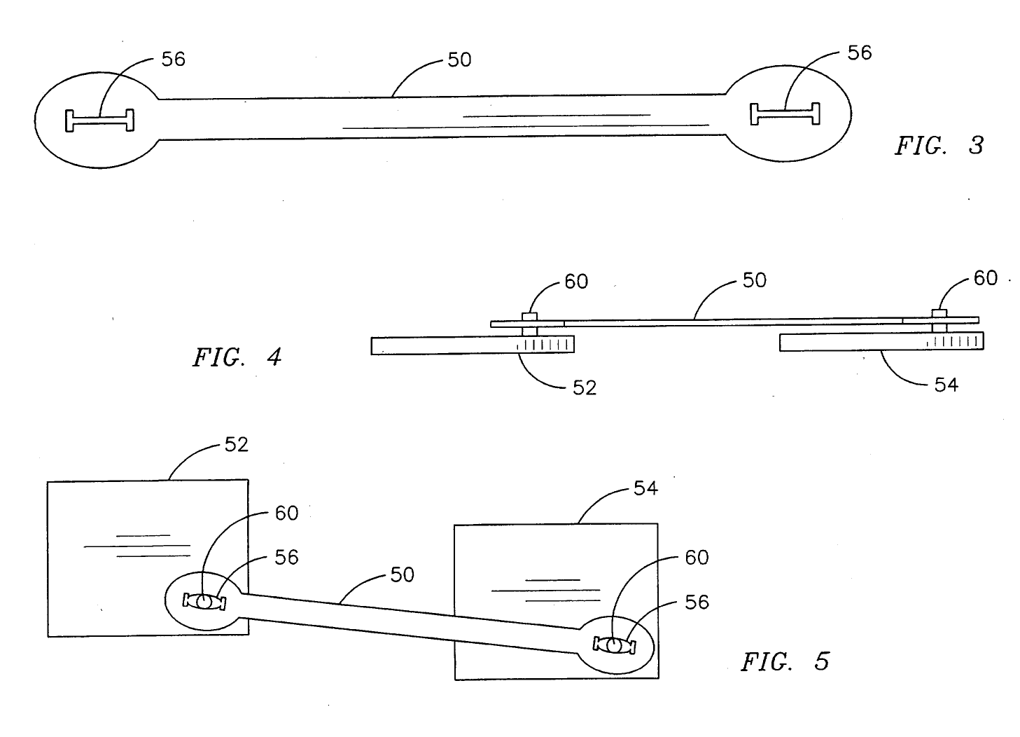

FIG. 3 illustrates an exemplary embodiment of the electrically conductive structure made up of a stamped lead frame 50 for interconnecting respective miniaturized PCB boards 52 and 54, as illustrated in FIGS. 4 and 5. In accordance with aspects of the invention, stamped lead frame 50 may include a respective slit 56 situated at opposite ends of the lead frame and generally extending along the longitudinal axis of the lead frame. As will be now appreciated by those skilled in the art, each slit 56 provides tolerance to spacing variation that may occur between respective connecting posts 60 on PCB boards 52 and 54. In essence, the aperture provided by each slit would be able to accommodate dimensional variations that may occur not just between the respective connecting posts 60 on PCB boards 52 and 54 but within the lead frame itself. Thus, the manufacturing tolerances for the lead frame need not be as tight as they would otherwise be in the absence of slits 56.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An electrical interface assembly for an ignition system including at least one ignition coil per cylinder in a multi-cylinder engine, each ignition coil including a plurality of coil terminals for passing respective electrical signals, one of the electrical signals used for discharging a respective spark in a respective cylinder, the interface assembly comprising:
a respective miniaturized printed circuit board (PCB) on each ignition coil, each miniaturized PCB electrically coupled to the coil terminals therein; and
separate electrically conductive structure for electrically interconnecting each miniaturized PCB, the electrically conductive structure configured to reduce ohmic losses due to inter-cylinder separation in the electrical signal used for discharging the respective spark.

2. The interface assembly of claim 1 wherein the size of the miniaturized PCB ranges from approximately 15 to 20 mm².

3. The interface assembly of claim 1 wherein the separate electrically conductive structure is selected from the group consisting of a set of round wires; a set of square terminal wires; and a set of stamped lead frames.

4. The interface assembly of claim 1 wherein the electrically conductive structure comprises a solderable structure relative to a set of connecting points on each miniaturized PCB.

5. The interface assembly of claim 1 wherein each miniaturized PCB includes an anchor post for affixing the PCB on an associated ignition coil.

6. The interface assembly of claim 1 wherein the separate electrically conductive structure comprises a set of round wires and wherein each PCB includes a set of wrap posts for wrappingly supporting and directing each respective round wire being connected therein.

7. The interface assembly of claim 1 wherein the separate electrically conductive structure comprises a set of square wires each including a respective bent to reach a respective coil terminal.

8. The interface assembly of claim 1 wherein the separate electrically conductive structure comprises a set of stamped lead frames each including a respective slit at opposite ends of the frame, the slit configured to extend generally along the longitudinal axis of the frame to provide tolerance to spacing variation that may occur between any two PCBs being connected with the frame.

9. The interface assembly of claim 1 wherein the separate electrically conductive structure comprises a set of stamped lead frames each including a respective slit at opposite ends of the frame, the slit configured to extend generally along the longitudinal axis of the frame to provide tolerance to length variation in any given lead frame.

10. An ignition system for a multi-cylinder engine, the system comprising:
at least one ignition coil per cylinder, each ignition coil including a plurality of coil terminals for passing respective electrical signals, one of the electrical signals used for discharging a respective spark in a respective cylinder; and
an electrical interface assembly comprising:
a respective miniaturized printed circuit board (PCB) on each ignition coil, each miniaturized PCB electrically coupled to the coil terminals therein; and
separate electrically conductive structure for electrically interconnecting each miniaturized PCB, the electrically conductive structure configured to reduce ohmic losses due to inter-cylinder separation in the electrical signal used for discharging the respective spark.

11. The ignition system of claim 10 wherein the size of the miniaturized PCB ranges from approximately 15 to 20 mm².

12. The ignition system of claim 10 wherein the separate electrically conductive structure is selected from the group consisting of a set of round wires; a set of square terminal wires; and a set of stamped lead frames.

13. The ignition system of claim 10 wherein the electrically conductive structure comprises a solderable structure relative to a set of connecting points on each miniaturized PCB.

14. The ignition system of claim 10 wherein each miniaturized PCB includes an anchor post for affixing the PCB on an associated ignition coil.

15. The ignition system of claim 10 wherein the separate electrically conductive structure comprises a set of round wires and wherein each PCB includes a set of wrap posts for wrappingly supporting and directing each respective round wire being connected therein.

16. The ignition system of claim 10 wherein the separate electrically conductive structure comprises a set of square terminal wires each including a respective bent to reach a respective coil terminal.

17. The ignition system of claim 10 wherein the separate electrically conductive structure comprises a set of stamped lead frames each including a respective slit at opposite ends of the frame, the slit configured to extend generally along the longitudinal axis of the frame to provide tolerance to spacing variation that may occur between any two PCBs being connected with the frame.

18. The ignition system of claim 10 wherein the separate electrically conductive structure comprises a set of stamped lead frames each including a respective slit at opposite ends of the frame, the slit configured to extend generally along the longitudinal axis of the frame to provide tolerance to length variation in any given lead frame.
